(19) United States
(12) Patent Application Publication
(10) Pub. No.: US 2025/0048166 A1
(43) Pub. Date: Feb. 6, 2025

(54) PATH SWITCH FOR UE-TO-UE RELAY COMMUNICATION

(71) Applicant: ZTE CORPORATION, Shenzhen (CN)

(72) Inventors: Mengzhen WANG, Shenzhen (CN); Lin CHEN, Shenzhen (CN); Wanfu XU, Shenzhen (CN); Weiqiang DU, Shenzhen (CN); Tao QI, Shenzhen (CN)

(73) Assignee: ZTE CORPORATION, Shenzhen (CN)

(21) Appl. No.: 18/927,136

(22) Filed: Oct. 25, 2024

Related U.S. Application Data
(63) Continuation of application No. PCT/CN2022/092065, filed on May 10, 2022.

(51) Int. Cl. H04W 24/10; H04W 72/25

(52) U.S. Cl. CPC H04W 24/10; H04W 72/25

(57) ABSTRACT

A wireless communication method for use in a first wireless terminal is disclosed. The method comprises receiving, from a first wireless network node, a sidelink (SL) measurement configuration associated with a user-to-user relay for the first wireless terminal and a second wireless terminal, and transmitting, to the first wireless network node, a measurement report based on the measurement configuration.

### CROSS-REFERENCE TO RELATED APPLICATION

This application claims the benefit of priority under 35 U.S.C. § 120 as a continuation of International Patent Application No. PCT/CN2022/092065, filed on May 10, 2022, the disclosure of which is incorporated herein by reference in its entirety.

### TECHNICAL FIELD

This document is directed generally to wireless communications, and in particular to sidelink (SL) communications, in particular in 5th generation communications.

### BACKGROUND

With the development of wireless multimedia services, demands for high data rate and great user experience continuously increase, resulting in higher requirements of the system compacity and coverage of conventional cellular networks. On the other hand, demands for proximity services also increase because of application scenarios such as public security, social network, near-field data sharing and local advertisement. Traditionally, the cellular network using the base station as the center may have obvious limitations on supporting the high data rates and the proximity service. In order to satisfy such requirements, device-to-device (D2D) communication technology is proposed. By applying the D2D communication technology, the burden of the cellular network can be relieved, the power consumption of the user equipment (UE) can be reduced, the data rate can be increased and the robustness of the network infrastructure can be improved. Thus, the demands for high data rate and proximity services are greatly satisfied. In this context, the D2D communication technology is also named proximity services (ProSe) or sidelink (SL) communications, wherein an interface between the UEs is called PC5 interface.

### SUMMARY

For supporting applications and services in a broader scope (e.g. indoor relay communication, smart agriculture, smart factory, public security, etc.), sidelink-based relay communications may be used to extend the coverage and improve the power consumption. For example, the sidelink-based communications may be applied in two application scenarios shown in FIG. 1:

1) UE-to-Network relay (Pattern 1): This type of relay is used for the UE in a weak/no coverage area. In FIG. 1, a UE1 in the weak/no coverage area is allowed to communicate with the network (e.g. base station) via a UE2 under a coverage of the network. The UE-to-Network relay may help the network operator to extend the coverage and increase the capacity of the network. Note that, in FIG. 1, the UE1 may be called remote UE and the UE2 may be called UE-to-Network relay.

2) UE-to-UE relay (Pattern 2): For an emergency scenario (e.g. an earthquake) of the network working abnormally or for extending a sidelink communication range, the UEs may be allowed to communicate with each other via relay UE(s). For example, UE3 and UE4 in FIG. 1 communicate with each other via a UE5 or multiple relay UEs. The UE5 may be called UE-to-UE (U2U) relay.

Regarding the U2U relay, a source UE (e.g. UE3 in FIG. 1) may directly communicate with a target UE (e.g. UE4 in FIG. 4) when the source UE and the target UE are within an SL communication range with each other. Due to movements of the source UE and/or the target UE, the source UE may not be able to directly communicate with the target UE and needs to find and search a U2U relay for relaying data between the source UE and the target UE. That is the communication path between the source UE and the target UE may be switched from a direct SL to a U2U relay link (e.g. indirect SL). In addition, the communication path between the source UE and the target UE may be switched from the U2U relay link to the direct SL. For the U2U relay related technologies, how to perform the path switch and how to ensure data service continuity during the path switch need to be considered.

This document relates to methods, systems, and devices for a path switch for SL communications, and in particular to methods, systems, and devices for a path switch for U2U Relay communications.

The present disclosure relates to a wireless communication method for use in a first wireless terminal. The method comprises:
receiving, from a first wireless network node, a sidelink, SL, measurement configuration associated with a user-to-user relay for the first wireless terminal and a second wireless terminal, and
transmitting, to the first wireless network node, a measurement report based on the measurement configuration.

Various embodiments may preferably implement the following features:

Preferably or in some embodiments, the SL measurement configuration comprises at least one of: at least one threshold used in a measurement report event, a filtering criterion of filtering the measurement report triggered by the measurement report event, or a measurement quantity associated with the user-to-user relay.

Preferably or in some embodiments, the measurement report event comprises at least one of: a link quality of a direct SL between the first wireless terminal and the second wireless terminal is lower than a first threshold, a link quality of a direct SL between the first wireless terminal and the second wireless terminal is lower than a second threshold and a link quality of a first hop between a first user-to-user relay candidate and the first wireless terminal is greater than a third threshold, a link quality of a first hop between a second user-to-user relay candidate and the first wireless terminal is greater than a fourth threshold, a link quality of a first hop between a third user-to-user relay candidate and the first wireless terminal and a link quality of a second hop between the third user-to-user relay candidate and the second wireless terminal are greater than a fifth threshold, link qualities of a first hop and a second hop of an indirect SL are lower than a sixth threshold, wherein the first hop is between the first wireless terminal and the user-to-user relay serving the indirect SL for the first wireless terminal and the second wireless terminal and the second hop is between the second wireless terminal and the user-to-user relay serving the indirect SL for the first wireless terminal and the second wireless terminal, or a link quality of the direct SL between the first wireless terminal and the second wireless terminal is greater than a seventh threshold.

Preferably or in some embodiments, the filtering criterion comprises at least one of: an eighth threshold configured to filter out a fourth user-to-user relay candidate if a link quality of a first hop between the fourth user-to-user relay candidate and the first wireless terminal is lower than the eighth threshold, or a ninth threshold configured to filter out a fifth user-to-user relay candidate if a link quality of a second hop between the fifth user-to-user relay candidate and the second wireless terminal is lower than the ninth threshold.

Preferably or in some embodiments, the SL measurement configuration is associated with an identifier, ID, of the second wireless terminal.

Preferably or in some embodiments, the wireless communication method further comprises receiving, from the first wireless network node, a path switch configuration indicating a path switch towards an indirect SL which is between the first wireless terminal and the second wireless terminal and served by a third wireless terminal.

Preferably or in some embodiments, the path switch configuration comprises at least one of: an ID of the second wireless terminal, an ID of the third wireless terminal, or a timer value of a path switch timer associated with the path switch.

Preferably or in some embodiments, the wireless communication method further comprises starting the path switch timer when receiving the path switch configuration.

Preferably or in some embodiments, the wireless communication method further comprises stopping the path switch timer at the time of at least one of: when a first PC5 link between the first wireless terminal and the third wireless terminal and a second PC5 link between the third wireless terminal and the second wireless terminal are established, transmitting, to the third wireless terminal, a radio resource control, RRC, reconfiguration SL message successfully, receiving, from the third wireless terminal, a PC5 radio link control acknowledge, receiving, from the third wireless terminal, an RRC reconfiguration complete SL message, receiving, from the second wireless terminal, a packet data convergence protocol, PDCP, acknowledge, receiving, from the third wireless terminal, an end-to-end direct communication response from the second wireless terminal via the third wireless terminal, transmitting, to the third wireless terminal, an end-to-end layer 2 link modification request message successfully, or receiving, from the third wireless terminal, an end-to-end layer 2 link modification accept message.

Preferably or in some embodiments, at an expiry of the path switch timer, the method further comprises at least one of: initiating a relay reselection procedure, or transmitting, to the first wireless network node, information of a path switch failure.

Preferably or in some embodiments, the wireless communication method further comprises transmitting, to the first wireless network node, information comprising at least one of a path switch failure indication, a PC5 link setup failure indication, an ID of the second wireless terminal, an indication of a first hop between the first wireless terminal and the third wireless terminal, or an indication of a second hop between the third wireless terminal and the second wireless terminal.

Preferably or in some embodiments, the wireless communication method further comprises receiving, from the third wireless terminal, a failure report indicating a failure of a PC5 link setup between the third wireless terminal and the second wireless terminal.

Preferably or in some embodiments, the wireless communication method further comprises comprising at least one of: transmitting, to the second wireless terminal, an end-to-end PC5 RRC reconfiguration message indicating a PDCP data recovery, transmitting, to the second wireless terminal, an end-to-end PC5 RRC message indicating a PDCP reestablishment, receiving, from the second wireless terminal, an end-to-end PC5 RRC reconfiguration message indicating a PDCP data recovery, receiving, from the second wireless terminal, an end-to-end PC5 RRC message indicating a PDCP reestablishment, receiving, from the first wireless network node, an SL configuration comprising at least one of an indication of a PDCP data recovery for an SL between the first wireless terminal and the second wireless terminal, an indication of a PDCP data recovery for each end-to-end SL data radio bearer, DRB, of an SL between the first wireless terminal and the second wireless terminal, an indication of a PDCP re-establishment for an SL between the first wireless terminal and the second wireless terminal, or an indication of a PDCP re-establishment for each end-to-end SL DRB of an SL between the first wireless terminal and the second wireless terminal, or performing a PDCP data recovery or a PDCP reestablishment after the path switch towards the indirect SL which is between the first wireless terminal and the second wireless terminal and served by the third wireless terminal.

Preferably or in some embodiments, the wireless communication method further comprises receiving, from the third wireless terminal, information of the second wireless terminal.

Preferably or in some embodiments, the information of the second wireless terminal comprises at least one of a radio resource control state, a serving cell information, or an outside-of-coverage indication.

Preferably or in some embodiments, the wireless communication method further comprises transmitting, to the first wireless network node, information of the second wireless terminal.

Preferably or in some embodiments, the information of the second wireless terminal comprises at least one of a radio resource control state, a serving cell information, or an outside-of-coverage indication.

Preferably or in some embodiments, the wireless communication method further comprises transmitting, to a third wireless terminal serving an indirect SL between the first wireless terminal and the second wireless terminal, a measurement configuration comprising an ID of the second wireless terminal.

Preferably or in some embodiments, the first wireless network node transmits, to a third wireless network node serving the second wireless terminal, SL related information.

Preferably or in some embodiments, the SL related information is (transmitted/generated) based on the SL measurement report and the information of the second wireless terminal received from the first wireless terminal UE.

Preferably or in some embodiments, the SL related information includes at least one of: an ID of the first wireless terminal, an ID of the second wireless terminal, a list of user-to-user relay candidate, a selected user-to-user relay, an RRC state of each user-to-user relay candidate, a PC5 link quality between the first wireless terminal and each user-to-user relay candidate, or a PC5 link quality between each user-to-user relay candidate and the second wireless terminal.

Preferably or in some embodiments, the first wireless network node receives, from the third wireless network node, a selected user-to-user relay for (relaying data transmissions between) the first wireless terminal and the second wireless terminal.

The present disclosure relates to a wireless communication method for use in a third wireless terminal. The method comprises receiving, from a wireless network node serving the third wireless terminal, a sidelink, SL, configuration associated with a user-to-user relay between a first wireless terminal and a second wireless terminal, and establishing a first PC5 link with the first wireless terminal and establishing a second PC5 link with the second wireless terminal based on the SL configuration.

Various embodiments may preferably implement the following features:

Preferably or in some embodiments, the SL configuration comprises at least one of: a user-to-user relay indication, at least one identifier, ID, associated with the first wireless terminal and the second wireless terminal, a bearer mapping associated with an end-to-end SL radio bearer, SLRB, to a PC5 radio link control, RLC, channel of a first hop over an indirect SL, wherein the first hop is between the third wireless terminal and the first wireless terminal and the indirect SL is between the first wireless terminal and the second wireless terminal and is through the third wireless terminal, or a bearer mapping associated with an end-to-end SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal.

Preferably or in some embodiments, the bearer mapping comprises at least one of an end-to-end SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

Preferably or in some embodiments, the wireless communication method further comprises transmitting, to the first wireless terminal, a failure report indicating a failure of establishing the second PC5 link.

Preferably or in some embodiments, the wireless communication method further comprises transmitting, to the first wireless terminal, information of the second wireless terminal, wherein the information comprises at least one of a radio resource control state, a serving cell information, or an outside-of-coverage indication.

Preferably or in some embodiments, the wireless communication method further comprises receiving, from the first wireless terminal, a measurement configuration comprising an ID of the second wireless terminal.

The present disclosure relates to a wireless communication method for use in a first wireless network node. The method comprises transmitting, to a first wireless terminal, a sidelink, SL, measurement configuration associated with a user-to-user relay for the first wireless terminal and a second wireless terminal, and receiving, from the first wireless terminal, a measurement report associated with the SL measurement configuration.

Various embodiments may preferably implement the following features:

Preferably or in some embodiments, the SL measurement configuration comprises at least one of: at least one threshold used in a measurement report event, a filtering criterion of filtering the measurement report triggered by the measurement report event, or a measurement quantity associated with the user-to-user relay.

Preferably or in some embodiments, the measurement report event comprises at least one of: a link quality of a direct SL between the first wireless terminal and the second wireless terminal is lower than a first threshold, a link quality of a direct SL between the first wireless terminal and the second wireless terminal is lower than a second threshold and a link quality of a first hop between a first user-to-user relay candidate and the first wireless terminal is greater than a third threshold, a link quality of a first hop between a second user-to-user relay candidate and the first wireless terminal is greater than a fourth threshold, a link quality of a first hop between a third user-to-user relay candidate and the first wireless terminal and a link quality of a second hop between the third user-to-user relay candidate and the second wireless terminal are greater than a fifth threshold, link qualities of a first hop and a second hop of an indirect SL are lower than a sixth threshold, wherein the first hop is between the first wireless terminal and the user-to-user relay serving the indirect SL for the first wireless terminal and the second wireless terminal and the second hop is between the second wireless terminal and the user-to-user relay serving the indirect SL for the first wireless terminal and the second wireless terminal, or a link quality of the direct SL between the first wireless terminal and the second wireless terminal is greater than a seventh threshold.

Preferably or in some embodiments, the filtering criterion comprises at least one of: an eighth threshold configured to filter out a fourth user-to-user relay candidate if a link quality of a first hop between the fourth user-to-user relay candidate and the first wireless terminal is lower than the eighth threshold, or a ninth threshold configured to filter out a fifth user-to-user relay candidate if a link quality of a second hop between the fifth user-to-user relay candidate and the second wireless terminal is lower than the ninth threshold.

Preferably or in some embodiments, the SL measurement configuration is associated with an identifier, ID, of the second wireless terminal.

Preferably or in some embodiments, the wireless communication method further comprises transmitting, to the first wireless terminal, a path switch configuration indicating a path switch towards an indirect SL which is between the first wireless terminal and the second wireless terminal and served by a third wireless terminal.

Preferably or in some embodiments, the path switch configuration comprises at least one of: an ID of the second wireless terminal, an ID of the third wireless terminal, or a timer value of a path switch timer for the path switch.

Preferably or in some embodiments, the wireless communication method further comprises receiving, from the first wireless terminal, information comprising at least one of a path switch failure indication, a PC5 link setup failure indication, an ID of the second wireless terminal, an indication of a first hop between the first wireless terminal and the third wireless terminal, or an indication of a second hop between the second wireless terminal and the third wireless terminal.

Preferably or in some embodiments, the wireless communication method further comprises transmitting, to the first wireless terminal, an SL configuration comprising at least one of an indication of a packet data convergence protocol, PDCP, data recovery for an SL between the first wireless terminal and the second wireless terminal, an indication of a PDCP data recovery for each end-to-end SL data radio bearer, DRB, of an SL between the first wireless terminal and the second wireless terminal, an indication of a PDCP re-establishment for an SL between the first wireless terminal and the second wireless terminal, or an indication of a PDCP re-establishment for each end-to-end SL DRB of an SL between the first wireless terminal and the second wireless terminal.

Preferably or in some embodiments, the wireless communication method further comprises transmitting, to a third wireless terminal, an SL configuration associated with a user-to-user relay between the first wireless terminal and the second wireless terminal.

Preferably or in some embodiments, the third wireless terminal is selected to be the user-to-user relay for the first wireless terminal and the second wireless terminal based on the measurement report.

Preferably or in some embodiments, the SL configuration comprises at least one of: a user-to-user relay indication, an ID of the first wireless terminal, an ID of the second wireless terminal, a bearer mapping associated with an end-to-end SL radio bearer, SLRB, to a PC5 radio link control, RLC, channel of a first hop over an indirect SL, wherein the first hop is between the third wireless terminal and the first wireless terminal and the indirect SL is between the first wireless terminal and the second wireless terminal and is through the third wireless terminal, or a bearer mapping associated with an end-to-end SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal.

Preferably or in some embodiments, the bearer mapping comprises at least one of an end-to-end SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

Preferably or in some embodiments, the wireless communication method further comprises transmitting, to a second wireless network node, SL relay assistance information associated with a third wireless terminal.

Preferably or in some embodiments, the third wireless terminal is selected to be a user-to-user relay for the first wireless terminal and the second wireless terminal based on the measurement report.

Preferably or in some embodiments, the third wireless terminal is served by the second wireless network node.

Preferably or in some embodiments, the SL relay assistance information comprises at least one of: serving cell information of the third wireless terminal, an ID of the third wireless terminal, an ID of the first wireless terminal, an ID of the second wireless terminal, a bearer mapping between an SL signaling radio bearer, SRB and a PC5 RLC channel, a mapping between an SL data radio bearer, DRB, and at least one quality of service, QoS, flow, a bearer mapping between an SL DRB and a PC5 RLC channel, a packet delay budget, PDB, associated with each PC5 RLC channel, a PDB associated with each SL DRB, a control plane indication of each PC5 RLC channel, or a channel configuration for each PC5 RLC channel.

Preferably or in some embodiments, the wireless communication method further comprises receiving, from the first wireless terminal, information of the second wireless terminal.

Preferably or in some embodiments, the information of the second wireless terminal comprises at least one of a radio resource control state, a serving cell information, or an outside-of-coverage indication.

The present disclosure relates to a wireless communication method for use in a second wireless network node. The method comprises receiving, from a first wireless network node, a sidelink, SL, relay assistance information associated with a third wireless terminal selected to be a user-to-user relay for a first wireless terminal and a second wireless terminal, and transmitting, to the third wireless terminal, an SL configuration associated with the user-to-user relay between the first wireless terminal and the second wireless terminal.

Various embodiments may preferably implement the following features:

Preferably or in some embodiments, the SL relay assistance information comprises at least one of: serving cell information of the third wireless terminal, an identifier, ID, of the third wireless terminal, an ID of the first wireless terminal, an ID of the second wireless terminal, a bearer mapping between an SL signaling radio bearer, SRB and a PC5 RLC channel, a mapping between an SL data radio bearer, DRB, and at least one quality of service, QoS, flow, a bearer mapping between an SL DRB and a PC5 RLC channel, a packet delay budget, PDB, associated with each PC5 RLC channel, a PDB associated with each SL DRB, a control plane indication of each PC5 RLC channel, or a channel configuration for each PC5 RLC channel.

Preferably or in some embodiments, the SL configuration comprises at least one of a user-to-user relay indication, an ID of the first wireless terminal, an ID of the second wireless terminal, a bearer mapping associated with an end-to-end SL radio bearer, SLRB, to a PC5 radio link control, RLC, channel of a first hop over an indirect SL, wherein the first hop is between the third wireless terminal and the first wireless terminal and the indirect SL is between the first wireless terminal and the second wireless terminal and is through the third wireless terminal, or a bearer mapping associated with an end-to-end SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal.

Preferably or in some embodiments, the bearer mapping comprises at least one of an end-to-end SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

The present disclosure relates to a first wireless terminal, comprising:
a communication unit, configured to: receive, from a first wireless network node, a sidelink, SL, measurement configuration associated with a user-to-user relay for the first wireless terminal and a second wireless terminal, and transmit, to the first wireless network node, a measurement report based on the measurement configuration.

Various embodiments may preferably implement the following feature:

Preferably or in some embodiments, the first wireless terminal further comprises a processor configured to perform any of the aforementioned wireless communication methods.

The present disclosure relates to a third wireless terminal, comprising:
a communication unit, configured to receive, from a wireless network node serving the third wireless terminal, a sidelink, SL, configuration associated with a user-to-user relay between a first wireless terminal and a second wireless terminal, and
a processor, configured to establish a first PC5 link with the first wireless terminal and establishing a second PC5 link with the second wireless terminal based on the SL configuration.

Various embodiments may preferably implement the following feature:

Preferably or in some embodiments, the processor is further configured to perform any of the aforementioned wireless communication methods.

The present disclosure relates to a first wireless network node, comprising:
a communication unit, configured to: transmit, to a first wireless terminal, a sidelink, SL, measurement configuration associated with a user-to-user relay for the first wireless terminal and a second wireless terminal, and receive, from the first wireless terminal, a measurement report associated with the SL measurement configuration.

Various embodiments may preferably implement the following feature:

Preferably or in some embodiments, the first wireless network node further comprises a processor configured to perform any of the aforementioned wireless communication methods.

The present disclosure relates to a second wireless network node, comprising:
a communication unit, configured to: receive, from a first wireless network node, a sidelink, SL, relay assistance information associated with a third wireless terminal selected to be a user-to-user relay for a first wireless terminal and a second wireless terminal, and transmit, to the third wireless terminal, an SL configuration associated with the user-to-user relay between the first wireless terminal and the second wireless terminal.

Various embodiments may preferably implement the following feature:

Preferably or in some embodiments, the second wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of scenarios of sidelink relay communications.

FIGS. 2A and 2B shows schematic diagrams of a direct sidelink and an indirect sidelink according to an embodiment of the present disclosure.

FIG. 3 shows a schematic diagram of a signaling procedure according to an embodiment of the present disclosure.

FIG. 4 shows a schematic diagram of the SL measurement configuration and reporting according to an embodiment of the present disclosure.

FIG. 5 shows a schematic diagram of the path switch from the indirect SL to the direct SL according to an embodiment of the present disclosure.

FIG. 6 shows a schematic diagram of the path switch from an indirect SL to another indirect SL according to an embodiment of the present disclosure.

FIG. 7 shows an example of a schematic diagram of a wireless terminal according to an embodiment of the present disclosure.

FIG. 8 shows an example of a schematic diagram of a wireless network node according to an embodiment of the present disclosure.

FIGS. 9 to 12 are flowcharts of method according to embodiments of the present disclosure.

### DETAILED DESCRIPTION

In the present disclosure, at least one of X, Y and Z may represent at least one X and/or at least one Y and/or at least on Z, where each of X, Y and Z may be a condition, a criterion, a threshold, a measurement quantity, . . . , etc.

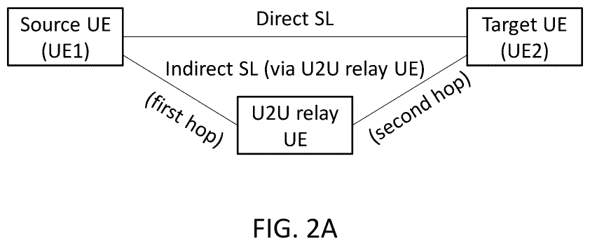

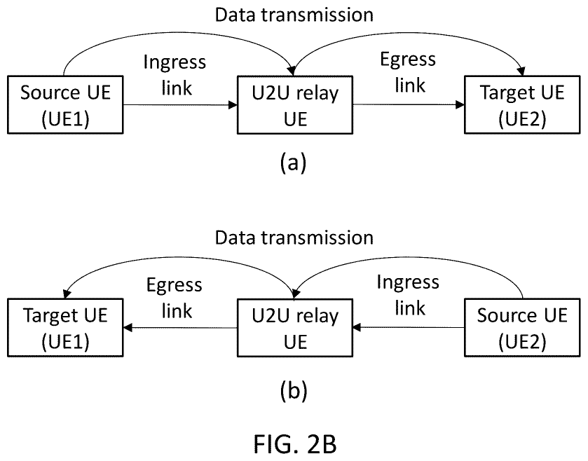

FIGS. 2A and 2B show schematic diagrams of a path switch according to an embodiment of the present disclosure. In FIG. 2A, a (communication) path between a source UE (e.g. UE1) and a target UE (e.g. UE2) may switch from a direct SL (i.e. two UEs directly communicate with each other) to an indirect SL (i.e. two UEs communicate with each other via a U2U relay UE), or vice versa. As shown in FIG. 2A, a link/path between the UE1 and the U2U relay UE is called first hop (of the indirect SL) in the present disclosure. In addition, a link/path between the UE2 and the U2U relay UE is called second hop (of the indirect SL) in the present disclosure.

In the present disclosure, the first hop may be equal to first PC5 hop.

In the present disclosure, the second hop may be equal to second PC5 hop.

In the present disclosure, a PC5 link may be equal to PC5 unicast link or a unicast link.

Based on a direction of data transmissions, the links between the UE1 and the U2U relay UE and between the UE2 and the U2U relay UE may be called by different names. In an embodiment shown in upper part (a) of FIG. 2B, the data is transmitted from the UE1 to the UE2. That is, in this embodiment, the UE1 is the source UE and the UE2 is the target UE. In this embodiment, for the U2U relay UE, the link between the UE1 and the U2U relay UE is called ingress link and the link between the UE2 and the U2U relay UE is called egress link. In an embodiment shown in lower part (b) of FIG. 2B, the data is transmitted from the UE2 to the UE1. In this embodiment, for the U2U relay UE, the link between the UE1 (i.e. target UE) and the U2U relay UE is called egress link and the link between the UE2 (source UE) and the U2U relay UE is called ingress link. Generally, for a UE, the egress link is an outbound link (i.e. to which data is transmitted) and the ingress link is an incoming link (i.e. from which data is received).

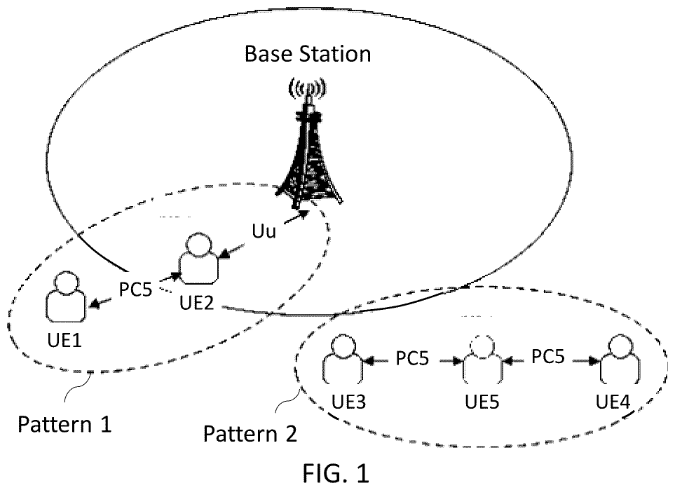

Note that the UE1 and UE2 in FIGS. 2A and 2B represent random UEs and may be different from those shown in FIG. 1.

Specifically, during the path switch from the direct link to the indirect link, the PC5 link between the source UE and the target UE may remain unchanged. The E2E (end-to-end) PC5 SDAP/PDCP (service data adaption protocol/packet data convergence protocol) and RRC (radio resource control) which are terminated at the source UE and the target UE may remain unchanged as well. When the path switches from the direct SL to the indirect SL, the direct PC5 RLC bearers (e.g. PC5 RLC bearers/PC5 RLC channels at the direct SL) are released while the data transmission are transferred to PC5 RLC bearers of the indirect SL. The service continuity is ensured by a PDCP data recovery or a PDCP re-establishment. In the present disclosure, the PC5 RLC bearer may be equal to PC5 RLC channel.

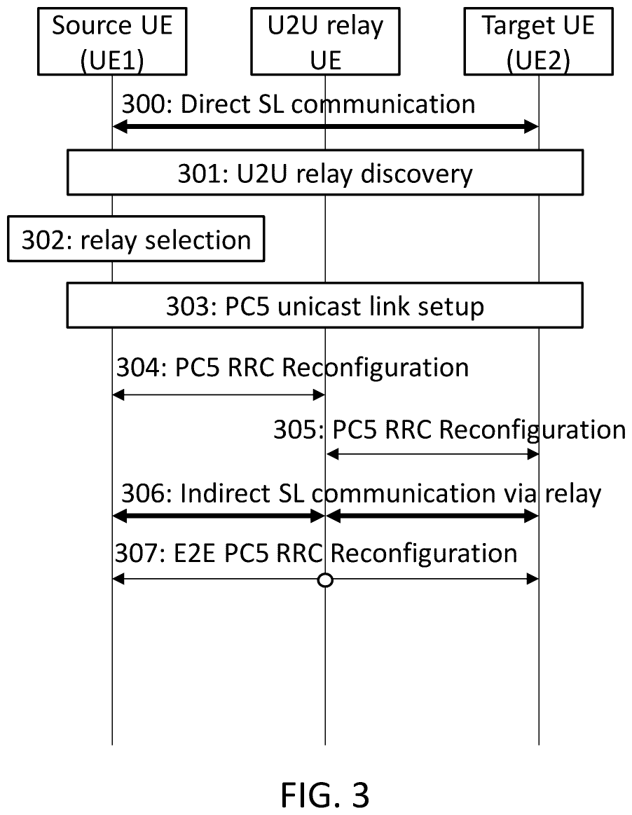

FIG. 3 shows a schematic diagram of a signaling procedure according to an embodiment of the present disclosure. In FIG. 3, the source UE and the target UE communicate with each other via the direct SL (step 300). If the link quality of the direct SL (i.e. direct PC5 link) becomes worse, the source UE may discover a U2U relay UE (which can reach both the source UE and the target UE) to forward SL traffics between the source UE and target UE (step 301). If multiple candidate relay UEs are discovered, the source UE may autonomously select (or based on some (pre) configured criteria) a relay UE (step 302). Next, the source UE may establish a PC5 link with the selected U2U relay UE, which may trigger the relay UE to establish a PC5 link with the target UE (step 304 and 305). In the steps 304 and 305, a QoS (quality-of-service) split may be performed by the relay UE and the source side PC5 QOS is sent to the source UE. After the completion of the PC5 link establishment over each hop (i.e. the first hop and the second hop), PC5 RLC bearers for transmitting E2E SL DRBs (data radio bearers) over each hop may be set up. The SL data transmission between the source UE and the target UE are transferred to indirect SL forwarded by relay UE (step 306). After or simultaneously with steps 304, 305 and 306, the source UE may initiate an E2E PC5 RRC reconfiguration which are forwarded by the relay UE, to release the direct PC5 RLC bearers on the direct SL (step 307).

In some embodiments, the path switch from the direct SL to the indirect SL may comprise an SL measurement configuration and reporting over the Uu interface.

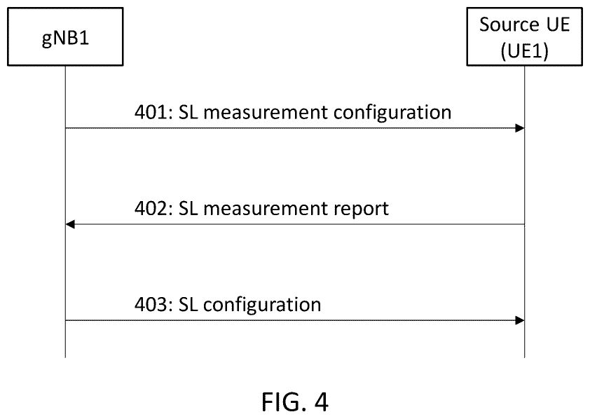

FIG. 4 shows a schematic diagram of the SL measurement configuration and reporting according to an embodiment of the present disclosure. In FIG. 4, if the source UE is in the RRC connected state, the source UE may receive the SL measurement configuration for the U2U relay measurement from its serving gNB (i.e. gNB1) and the source UE may report results of a relay measurement to the serving gNB (steps 401 and 402). Based on the measurement report, the gNB1 may select a (U2U) relay UE for the source UE and inform the selected relay UE (e.g. L2 ID (layer 2 identifier) of the relay UE) to the source UE. The SL measurement configuration may include threshold(s) related to SL measurement report event(s) and/or a measurement quantity and/or filtering criterion/criteria of the SL measurement report.

In an embodiment, the SL measurement configuration may be configured per destination/target UE.

In an embodiment, the SL measurement report event(s) may be/comprise at least one of the following events:

1) the link quality of the direct SL (the link quality between the source UE and the target UE, SL-RSRP (SL reference signal received power) or SD-RSRP (SL discovery reference signal received power)) is below a threshold TH1.

In this event, the SL-RSRP may be measured as the measurement quantity

In this event, the SD-RSRP may be measured (only) if the SL-RSRP is not available.

2) the link quality of the direct SL is below a threshold TH2 and the link quality of the first (PC5) hop of a candidate indirect SL (the link quality between the source UE and a candidate relay UE, SD-RSRP or SL-RSRP) is greater than a threshold TH3.

In the event (2), the SD-RSRP may be measured as the link quality of candidate indirect SLs.

In the event (2), if the SL-RSRP is available, the SL-RSRP is used as the link quality.

3) the link quality of the first hop of a candidate indirect SL is greater than a threshold TH4.

4) the link quality of the second hop of a candidate indirect SL is greater than a threshold TH5.

5) both the link quality of the first hop and the second hop of a candidate indirect SL are greater than a threshold TH6.

6) any combination of the above events (1) to (5).

In an embodiment, the link quality in the events (1) to (6) may be the SL-RSRP or the SD-RSRP. In addition, the thresholds can be thresholds for the SL-RSRP or the SD-RSRP.

In an embodiment, the combination of two or more of the above events (1) to (5), the thresholds used in the combined event may be the same or different.

In an embodiment, the filtering criterion is/comprises threshold(s) of filtering out (e.g. removing) the U2U relay candidate having a link quality smaller/lower than the thresholds.

For example, the filtering criterion/criteria of SL measurement report may include at least one of:

1) A threshold TH7 associated with filtering out a candidate indirect SL if the link quality of the second hop of the candidate indirect SL is below than the threshold TH7.

2) A threshold TH8 associated with filtering out a candidate indirect SL if the link quality of the first hop of the candidate indirect SL is below than the threshold TH8.

3) The maximum number of candidate relay UEs.

4) A priority threshold associated with filtering out a candidate indirect SL if a priority or a weight of a measurement report event associated with (reporting) the candidate indirect SL is lower than the priority threshold.

In an embodiment, if any of the measurement report events meets/occurs, the occurred measurement report event(s) may trigger the source UE to report the corresponding SL measurement results. The SL measurement results may be reported per destination/target UE. In addition, the source UE may filter the measurement results for the report according to the filtering criterion/criteria, if configured. Specifically, the SL measurement report may include at least one of: destination/target UE ID, the link quality of direct SL with the destination/target UE, a candidate relay UE ID (e.g. L2 ID, C-RNTI, local ID of the candidate relay UE), a serving cell of a candidate relay UE (e.g. NCGI, NCI, PCI), the link quality of the first hop of a candidate relay UE (the link quality between the source UE and the candidate relay UE), or the link quality of the second hop of a candidate relay UE (the link quality between the candidate relay UE and the target UE). In an embodiment, the source UE may acquire/receive the link quality of the second hop of the candidate relay UE from a discovery message sent by this candidate relay UE.

In some embodiments, the path switch from the direct SL to the indirect SL may comprise a configuration from the gNB to the source UE.

In an embodiment, after receiving the measurement report from the source UE, the gNB1 may select one relay UE for the source UE and send a path switch configuration to the source UE. Specifically, the path switch configuration may include at least one of: the destination/target UE ID, the ID of the selected relay UE (e.g. L2 ID of the relay UE), or a timer value for a path switch timer used in the path switch. In an embodiment, the source UE starts the path switch timer when/after receiving the path switch configuration from the gNB1. In an embodiment, the source UE may stop the path switch timer in at least one of the following cases:

1) When both PC5 links between the source UE and the relay UE and between the relay UE and the target UE are established successfully.

For example: when receiving, from the relay UE, a direct communication response, wherein the relay UE sends the direct communication response message to the source UE after the relay UE receives direct communication response from the target UE.

2) Successfully sending an RRCReconfigurationSidelink message to the relay UE. For example: when receiving PC5 RLC acknowledge from the relay UE.

3) Successfully receiving an RRCReconfigurationCompleteSidelink from the relay UE.

4) Successfully sending or receiving the E2E RRCReconfigurationSidelink/RRCReconfigurationCompleteSidelink to/from the relay UE.

5) Receiving a PDCP acknowledge from the target UE.

6) Receiving an E2E direct communication response from the target UE forwarded by the relay UE.

7) Successfully sending/receiving an E2E L2 link modification request/L2 link modification accept message to/from the relay UE.

At the expiry of the path switch timer, the source UE may initiate a relay reselection or report a path switch failure to the gNB1. In an embodiment, the source UE may reuse SL configuration failure as the path switch failure. In addition, the SL configuration from the gNB1 to the source UE may further include an indication of releasing the direct PC5 RLC bearers of the target UE.

When receiving the path switch configuration from the gNB, the source UE may initiate a PC5 link setup with the selected relay UE, which may further trigger another PC5 link setup between the selected relay UE and the target UE.

In an embodiment, the PC5 link setup between the source UE and the relay UE may fail. In this embodiment, the source UE may report a path switch failure or a PC5 link setup failure to the gNB immediately or after the path switch timer expires (i.e. at an expiry of the path switch timer). In an embodiment, the reporting information for the path switch failure or the PC5 link setup failure may include/indicate at least one of a path switch failure (indication), a PC5 link setup failure (indication), a target UE ID, a first hop indication, or a second hop indication. For example, the target UE ID may be used to indicate that the path switch failure or the PC5 link setup failure occurs between the source UE and the indicated UE (i.e. target UE). The first hop indication is configured to indicate that the path switch failure or the PC5 link setup failure occurs between the first hop (between the source UE and the U2U relay UE). The second hop indication is configured to indicate that the path switch failure or the PC5 link setup failure occurs between the second hop (between the target UE and the U2U relay UE).

In an embodiment, the PC5 link setup between the relay UE and target UE may fail. Under such conditions, the relay UE may inform the source UE about the failure of the PC5 link setup with the target UE. For instance, the information for the failure may include the target UE ID and/or a PC5 link setup failure indication. Upon receiving the information from the relay UE, the source UE may report the failure between the relay UE and the target UE to the gNB1 immediately or after the path switch timer expires. For example, the reporting information may include at least one of the target UE ID, the relay UE ID, the PC5 link setup failure indication, or a second hop indication.

In some embodiments, the path switch from the direct SL to the indirect SL may involve a configuration from the gNB to the selected relay UE.

In an embodiment, the selected relay UE is in the RRC connected state under the same gNB (i.e. gNB1) as the source UE. After selecting the relay UE, the gNB1 may send an SL related configuration to the relay UE. Specifically, the SL related configuration may include at least one of: the U2U relay indication, an ID of the source-destination UE pair (e.g. the L2 ID of the source UE, the L2 ID of the target UE), a PC5 RLC bearer configuration between the source UE and the relay UE, a PC5 RLC bearer configuration between the relay UE and the target UE, or a bearer mapping configuration between the E2E SLRBs to the first hop and second hop PC5 RLC bearers over the indirect SL. In an embodiment, the bearer mapping configuration may include at least one of: an E2E SLRB ID, a first hop PC5 RLC channel ID, a second hop PC5 RLC channel ID, an ingress PC5 RLC channel ID, an egress PC5 RLC channel ID, a PC5 RLC channel ID between the source UE and the relay UE, or a PC5 RLC channel ID between the relay UE and the target UE.

In an embodiment, the SL measurement configuration may be configured to the relay UE. Based on the SL measurement configuration, the relay UE measures both the PC5 link quality of the first hop and the second hop and reports the SL measurement results. Specifically, the SL measurement report may include at least one of: peer UE ID (e.g. L2 ID of the source UE or L2 ID of the target UE), or the PC5 link quality between the peer UE and the relay UE.

In some embodiments, the path switch from the direct SL to the indirect SL may comprise a coordination between gNBs of the source UE, the relay UE and the target UE.

In an embodiment, the relay UE is in the RRC connected state under a gNB (e.g. gNB2) which is different from the gNB1 of the source UE. In this embodiment, the gNB1 may send SL relay assistance information to the gNB2, to allow the gNB2 to make configuration(s) for the relay UE. The SL relay assistance information may include at least one of: serving cell information of the relay UE, the relay UE identity (L2 ID of the relay UE), the L2 ID of the source UE, the L2 ID of the target UE, the SL SRB to the PC5 RLC channel mapping (e.g. each SL SRB ID is mapped to a PC5 RLC channel ID), an SL DRB to QoS flow mapping (e.g. for each SL DRB ID, the QFI mapped to the SL DRB and the QoS profile of each QFI), an SL DRB to PC5 RLC channel mapping (e.g. each SL DRB ID is mapped to a PC5 RLC channel ID), a PDB associated to a PC5 RLC channel, a PDB associated to an SL DRB, a control plane indication of a PC5 RLC channel (e.g. indicating the PC5 RLC channel is used to transmit control plane traffic or to transmit a specific SL SRB ID), or a PC5 RLC channel configuration (e.g. for each PC5 RLC channel ID, the RLC and Logical channel configuration). The SL relay assistance information may be sent via non UE-associated Xn messages such as an Xn setup request, an NG-RAN node configuration update, a mobility change request, an access and mobility indication message and other new defined Xn message(s).

In an embodiment, if the gNB2 allows the relay UE to act as the relay for the source-target UE pair upon/after receiving the SL relay assistance information from the gNB1, the gNB2 may send a response message to the gNB1. The response message may include at least one of: the relay UE ID, or the L2 IDs of associated source UE and target UE. In this embodiment, the gNB2 may send a configuration to the relay UE, where the configuration may include at least one of: L2 IDs of the source UE and target UE pair, the mapping of SL DRB and PC5 RLC channel between the source UE and the relay UE, the mapping of SL DRB and PC5 RLC channel between the relay UE and the target UE, or PC5 RLC channel configuration.

In an embodiment, if the gNB1 intends to select a relay UE for the source UE and target UE pair after receiving the measurement report from the source UE, the gNB1 may need aware whether/how it can communicate with the gNB of the target UE (e.g. gNB3) and to coordinate with the gNB3 to select the relay UE (or to inform the gNB3 about the selected relay UE). In this embodiment, the source UE may need to know the target UE information, such as the RRC state of the target UE and/or serving cell information of the target UE and/or an out-of-coverage indication, and report the target UE information to the gNB1. The source UE may report the target UE information to the gNB1 in an SL measurement report or SL UE information. In an embodiment, the source UE may acquire the target UE information from discovery message(s) of the target UE or discovery message(s) of the relay UE.

In an embodiment, if the target UE is in the RRC connected state, the gNB1 may send SL related information to the gNB3 based on the SL measurement report and the target UE information from the source UE. The SL related information may include at least one of: the L2 ID of source UE, the L2 ID of target UE, a list of candidate relay UEs, a selected relay UE, the RRC state of each candidate/selected relay UE, a PC5 link quality between source UE and each candidate relay UE, or a PC5 link quality between each candidate relay UE and the target UE. The gNB3 may respond the gNB1 with a selected relay UE for a source-target UE pair.

In some embodiments, a service continuity may need to be considered during the path switch from the direct SL to the indirect SL.

In an embodiment, the logic channel ID (LCID) (e.g. LSB 5 bits of the LCID) of each E2E SL DRB at the direct SL may be continuously used as the SL security input in the indirect SL. If the SL security input is unchanged/not reconfigured, a PDCP data recovery may be performed. If the SL security is changed/reconfigured (e.g. a fictitious bearer ID/LCID for each E2E SL DRB is included in an E2E PC5 RRC reconfiguration, or a fictitious bearer ID/LCID is included in an adaptation layer header or a PDCP header), a PDCP re-establishment may be performed. During the PDCP data recovery or the PDCP re-establishment, the data transmissions over the direct SL/E2E SL DRB are performed via the indirect SL, to transmit the data via using the PC5 RLC bearers at each hop.

In an embodiment, the source UE may indicate the PDCP data recovery or the PDCP re-establishment to the target UE via E2E PC5 RRC reconfiguration/messages. In another embodiment, the source UE may receive a PDCP data recovery indication or a PDCP re-establishment indication from the target UE via the E2E PC5 RRC messages. In still another embodiment, the sidelink configuration from the gNB to the source UE may include at least one of: the indication of the PDCP data recovery for SL (per UE), the indication of the PDCP data recovery of a E2E SL DRB (per SL DRB), the indication of the PDCP re-establishment for SL, or the indication of the PDCP re-establishment of a E2E SL DRB. The source UE may perform the PDCP data recovery or the PDCP re-establishment by default when path switches from the direct SL to the indirect SL. That is the source UE may retransmit the packets (PDCP SDUs/PDUs) on the indirect SL for which the successful delivery has not been confirmed by the layer lower than the PDCP layer of the direct SL.

In an example, the SL path between two UEs may switch from the indirect SL to the direct SL.

In some embodiments, the source UE (e.g. UE1) communicates with the target UE (e.g. UE2) via a U2U relay UE. The UE1 and/or UE2 may initiate a relay reselection/path switch if the UE1/UE2 detects that the PC5 link quality between UE1/UE2 and the relay UE is worsening. In an embodiment, the UE1 may be interested in the link quality of the second hop. Under such conditions, the source UE may configure the relay UE to measure the PC5 link quality of the second hop and to report the measurement results, to acquire the link quality of the second hop. In these embodiments, the measurement mechanism/signaling may need to indicate the destination/target UE ID to be measured and/or the destination/target UE ID of the measurement results.

In some embodiments of the path switch from the indirect SL to the direct SL, if the source UE is in the RRC connected state, the source UE may receive an SL measurement configuration for U2U relay measurement(s) from its serving gNB and report the results of the U2U relay measurement(s) to the gNB1 (i.e. the gNB serving the source UE). Based on the measurement report, the gNB 1 may determine to indicate the source UE to switch the path to the direct SL. The SL measurement configuration may include the threshold(s) related to SL measurement report event(s) and/or the measurement quantity and/or the filtering criterion/criteria of SL measurement report.

In an embodiment, the SL measurement report event(s) may comprise at least one of the following:
1) The link quality of the first hop of serving indirect SL (e.g. the link quality between the source UE and the current serving relay UE, SL-RSRP or SD-RSRP) is below a threshold TH9.

Note that the SL-RSRP may be measured as the measurement quantity. In an embodiment, the SD-RSRP is measured as the measurement quantity (only) if the SL-RSRP is not available.
2) The link quality of the direct SL is greater than a threshold TH10.
3) The link quality of the first hop of the serving indirect SL is lower than a threshold TH11 and the link quality of the direct SL is greater than a threshold TH12, wherein the thresholds TH11 and TH12 may be the same or different.
4) The link quality of the first hop of the serving indirect SL is below a threshold TH13 and the link quality of the second hop of the serving indirect SL (e.g. the link quality between the current serving relay UE1 and the target UE) is below a threshold TH14, wherein the thresholds TH13 and TH14 may be the same or different.
5) The link quality of the first hop of the serving indirect SL is below a threshold TH15, the link quality of the second hop of the serving indirect SL is below a threshold TH16, the link quality of the direct SL is greater than a threshold TH17, wherein the thresholds TH15, TH16 and TH17 may be the same or different.
6) Any combination of the above events to generate new events.

In an embodiment, the SL-RSRP is measured as the measurement quantity in the SL measurement report event(s). In an embodiment, only if the SL-RSRP is not available, the SD-RSRP is measured as the measurement quantity in the SL measurement report event(s).

In an embodiment of combining two or more SL measurement report events (e.g. when the source UE communicates with the target UE via the U2U relay), the thresholds used in the SL measurement report events may be the same or different.

In an embodiment, after receiving the SL measurement report from the source UE, the gNB may indicate the source UE to perform the path switch to the direct SL. For example, the gNB may transmit a configuration to the source UE, where the configuration may include at least one of: indication of the path switch to the direct SL, the direct PC5 RLC bearers associated with E2E SL DRBs, or a timer value of a path switch timer.

In an embodiment, the UE starts the path switch timer upon receiving, from the gNB1, the configuration indicating the path switch. The stop condition of the path switch timer may be at least one of:
1) successfully sending an L2 link/ID modification request message to the target UE in the direct SL, (e.g. PC5 RLC acknowledge is received from target UE).
2) successfully receiving an L2 link/ID modification accept message from target UE.

At the expiry of the path switch timer, the UE may report the path switch failure (or the SL RLF indication or the SL config failure indication) to the network and/or initiate a relay reselection.

In an embodiment, upon receiving gNB configuration, the source UE may initiate a PC5 RRC reconfiguration (specified SL-SRB3, Timer 400) with the target UE, to setup a direct PC5 RLC bearers for the SL DRBs.

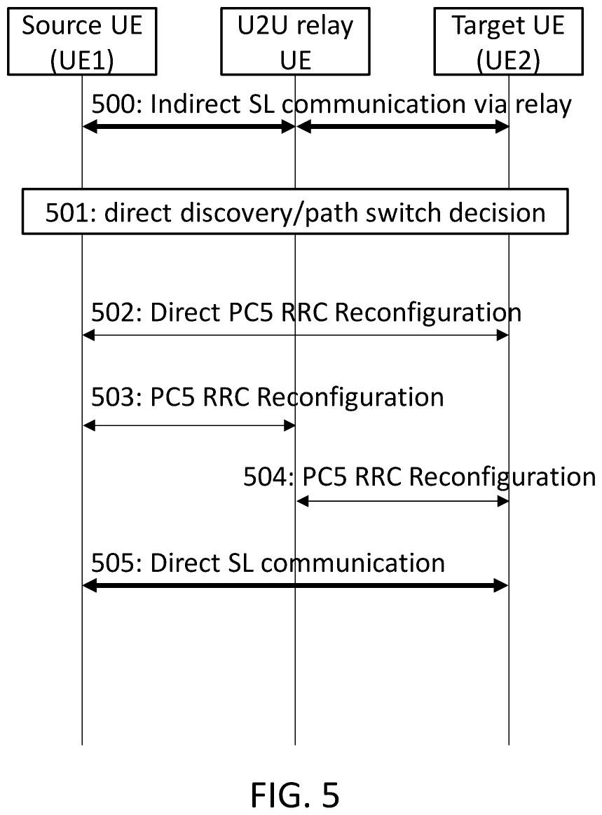

FIG. 5 shows a schematic diagram of the path switch from the indirect SL to the direct SL according to an embodiment of the present disclosure.

In step 500, the source UE and the target UE communicates via the U2U relay UE (i.e. indirect SL).

In step 501, the source UE and/or the target UE may initiate a relay reselection/path switch if the UE1/UE2 detects that the PC5 link quality between UE1/UE2 and the relay UE is getting worse, to switch from the indirect SL to the direct SL. As an alternative, the source UE may receive, from the serving gNB, a path switch indication of the path switch from the indirect SL to the direct SL.

In step 502, the source UE performs direct PC5 RRC Reconfiguration with the target UE, to configured direct PC5 RLC channels for SL DRBs.

In step 503, the source UE performs the PC5 RRC Reconfiguration with the U2U relay UE, to release related PC5 RLC channels or bearer mapping on the first hop.

In step 503, the source UE performs the PC5 RRC Reconfiguration with the U2U relay UE, to release related PC5 RLC channels or bearer mapping on the first hop.

In step 504, the target UE performs the PC5 RRC Reconfiguration with the U2U relay UE, to release related PC5 RLC channels or bearer mapping on the second hop.

In step 505, the source UE communicates with the target UE via the direct SL.

In an example, the SL path between two UEs may switch from an indirect SL (e.g. SL1) to another indirect SL (e.g. SL2).

In some embodiments, during the path switch, an extended PC5 link between the source UE and the target UE may remain unchanged. The E2E PC5 SDAP/PDCP and RRC which are terminated at the source UE and the target UE may remain unchanged as well. When the path switches from the indirect SL1 to the indirect SL2, the first hop and second hop PC5 RLC bearers over indirect SL1 are released while the data transmission are transferred to PC5 RLC bearers of the indirect SL2.

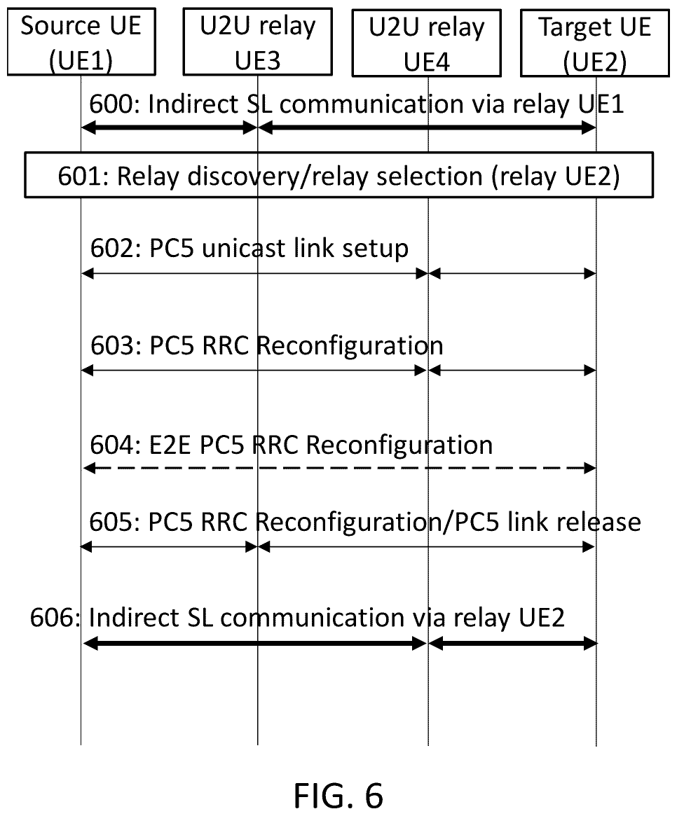

FIG. 6 shows a schematic diagram of the path switch from an indirect SL to another indirect SL according to an embodiment of the present disclosure.

In steps 600 and 601, the source UE communicates with the target UE via a U2U relay UE3. If the source UE/target UE detects the PC5 link quality towards relay UE3 is getting worse, the source UE/target UE may discover other candidate relay UEs. If multiple candidate relay UEs are discovered, the source UE/target UE may select one candidate relay UE (e.g. relay UE4).

If the source/target UE is in RRC connected state, it may receive SL measurement configuration for U2U relay measurement from its serving gNB and report the results of relay measurement to the gNB. The SL measurement configuration may include the thresholds related to SL measurement report events and/or the measurement quantity and/or the filtering criteria of SL measurement report. The SL measurement report events may be at least one of the following:

1) The link quality of the first hop of the serving indirect SL (the link quality between the source UE and the current serving relay UE (i.e. relay UE3 in FIG. 6), SL-RSRP or SD-RSRP) is below a threshold TH18.

In an embodiment, as a baseline, the SL-RSRP is measured as the measurement quantity.

In an embodiment, (only) if the SL-RSRP is not available, the SD-RSRP is measured as the measurement quantity.

2) The link quality of the first hop of a candidate indirect SL (the link quality between the source UE and a candidate relay UE (e.g. relay UE4 in FIG. 6), SD-RSRP or SL-RSRP) is greater than a threshold TH19.

3) The link quality of the first hop of the serving indirect SL is below a threshold TH20 and the link quality of the first hop of a candidate indirect SL is greater than a threshold TH21, wherein the thresholds TH20 and TH21 may be the same or different.

4) The link quality of the first hop of the serving indirect SL and the link quality of the second hop of the serving indirect SL are below than a threshold TH22.

5) The link quality of the first hop of a candidate indirect SL and the link quality of the second hop of this candidate indirect SL are greater than a threshold TH23.

6) The link quality of the first hop of the serving indirect SL and the link quality of the second hop of the serving indirect SL are below than a threshold TH24, and the link quality of the first hop of a candidate indirect SL and the link quality of the second hop of this candidate indirect SL are greater than a threshold TH25, wherein the thresholds TH24 and TH25 may be the same or different.

7) The link quality of the second hop of serving indirect SL (the link quality between the current serving relay UE3 and the target UE) is below a threshold TH26.

8) The link quality of the second hop of a candidate indirect SL is greater than a threshold TH27.

9) Any combination of the above events to generate new events.

In an embodiment of combining two or more SL measurement report events (e.g. when the source UE communicates with the target UE via the U2U relay), the thresholds used in the SL measurement report events may be the same or different.

In an embodiment, the filtering criterion is/comprises threshold(s) of filtering out (e.g. removing) the U2U relay candidate having a link quality smaller/lower than the thresholds.

For example, the filtering criterion/criteria of SL measurement report may include at least one of:

1) A threshold TH28 associated with filtering out a candidate indirect SL if the link quality of the second hop of the candidate indirect SL is below than the threshold TH28.

2) A threshold TH29 associated with filtering out a candidate indirect SL if the link quality of the first hop of the candidate indirect SL is below than the threshold TH27.

3) The maximum number of candidate relay UEs.

4) A priority threshold associated with filtering out a candidate indirect SL if a priority or a weight of a measurement report event associated with (reporting) the candidate indirect SL is lower than the priority threshold.

Based on the measurement report, the gNB1 of the source UE may select a relay UE for the source UE and inform the selected relay UE (e.g. the L2 ID of the relay UE4) to the source UE. That is, the gNB1 may send a path switch configuration to the source UE. The path switch configuration can be referred to the above discussed path switch configuration and is not discussed herein for brevity.

In an embodiment, if the selected relay UE is under the same gNB1 as the source UE and in RRC connected state, the gNB1 may send an SL related configuration to the selected relay UE4, for preparation for the path switch. The path switch configuration can be referred to the aforementioned SL related configuration and is not discussed herein for brevity.

In steps 602 and 603, the source UE and the target UE establishes PC5 link with the selected target relay UE4 respectively. The PC5 RRC reconfiguration is performed between the source UE and relay UE4 and between the relay UE4 and the target UE, to configure PC5 RLC channels for E2E SL DRBs over each hop (i.e. the first hop between the source UE and the relay UE4 and the second hop between the target UE and the relay UE4).

In step 604, an E2E PC5 RRC reconfiguration may be performed between the source UE and the target UE to reconfigure the E2E SL DRBs (e.g. configure a fictitious LCID for SL security input, add/mod/release E2E SL DRBs, etc.).

In step 605, the source UE may release the bearer mapping between E2E SL DRBs and first hop PC5 RLC channels (between the source UE and the relay UE3). If there is no relay traffic mapped to a PC5 RLC channel (between the source UE and the relay UE3), a PC5 RRC reconfiguration may be performed to release the PC5 RLC channel. If there is no relay traffic between source UE and relay UE3, the PC5 link may be released. The relay UE3 may release the bearer mapping of E2E SL DRBs/first hop PC5 RLC channels/ingress PC5 RLC channels and second hop PC5 RLC channels/egress PC5 RLC channels (between relay UE3 and target UE). If there is no relay traffic mapped to a PC5 RLC channel (between relay UE3 and target UE), a PC5 RRC reconfiguration may be performed to release the PC5 RLC channel. If there is no relay traffic between relay UE3 and the target UE, the PC5 link may be released.

In step 606, data are transferred from the source relay link to the target relay link. Note that the PDCP data recovery or the PDCP re-establishment may be performed based on the indication (e.g. from the serving gNB or from the peer UE).

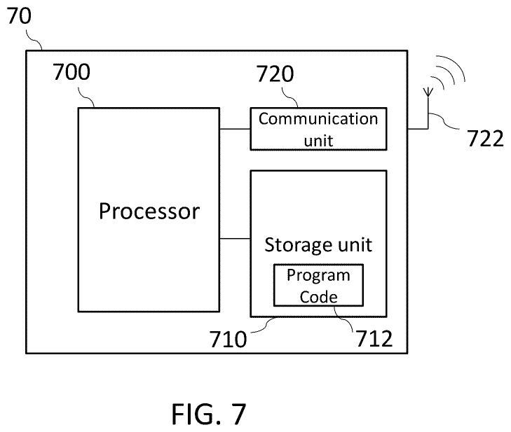

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 710 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g. messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g. a base station).

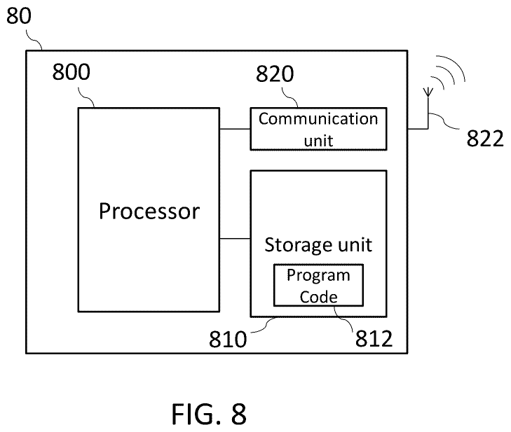

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 810 include but are not limited to a SIM, ROM, flash memory, RAM, hard-disk, and optical data storage device. The communication unit 820 may be a transceiver and is used to transmit and receive signals (e.g. messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g. a user equipment or another wireless network node).

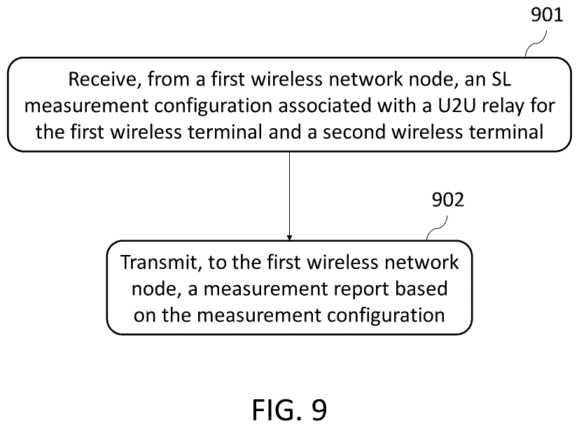

FIG. 9 shows a flowchart of a method according to an embodiment of the present disclosure. The method shown in FIG. 9 may be used in a first wireless terminal (e.g. UE or source UE) and comprises the following steps:

Step 901: Receive, from a first wireless network node, an SL measurement configuration associated with a U2U relay for the first wireless terminal and a second wireless terminal.

Step 902: Transmit, to the first wireless network node, a measurement report based on the measurement configuration.

In the embodiment of FIG. 9, the first wireless terminal receives an SL measurement configuration from a first wireless network node (e.g. the serving gNB of the first wireless terminal). The SL measurement configuration is associated with a U2U relay. More particularly, the SL measurement configuration is associated with the U2U relay between the first wireless terminal and a second wireless terminal (e.g. another UE or target UE). The SL measurement configuration may be configured for any second wireless terminal. As an alternative, the SL measurement configuration may be configured for a specific second wireless terminal. That is the SL measurement configuration may be configured per second wireless terminal. Based on the SL measurement configuration, the first wireless terminal transmits a measurement report to the first wireless network node.

In an embodiment, the SL measurement configuration comprises at least one of:
threshold(s) used in a measurement report event,
filtering criterion/criteria of filtering the measurement report triggered by the measurement report event, or
measurement quantity/quantities associated with the U2U relay.
   In an embodiment, the measurement report event comprises at least one of:
a link quality of a direct SL between the first wireless terminal and the second wireless terminal is lower than a first threshold,
a link quality of a direct SL between the first wireless terminal and the second wireless terminal is lower than a second threshold and a link quality of a first hop between a first U2U relay candidate and the first wireless terminal is greater than a third threshold,
a link quality of a first hop between a second U2U relay candidate and the first wireless terminal is greater than a fourth threshold,
a link quality of a first hop between a third U2U relay candidate and the first wireless terminal and a link quality of a second hop between the third U2U relay candidate and the second wireless terminal are greater than a fifth threshold,
link qualities of a first hop and a second hop of an indirect SL are lower than a sixth threshold, wherein the first hop is between the first wireless terminal and the U2U relay serving the indirect SL for the first wireless terminal and the second wireless terminal and the second hop is between the second wireless terminal and the U2U relay serving the indirect SL for the first wireless terminal and the second wireless terminal, or
a link quality of the direct SL between the first wireless terminal and the second wireless terminal is greater than a seventh threshold.

In an embodiment, the filtering criterion is/comprises threshold(s) of filtering out (e.g. removing) the U2U relay candidate having a link quality smaller/lower than the thresholds.

For example, the filtering criterion/criteria comprise at least one of:
an eighth threshold configured/used to filter out a fourth U2U relay candidate if a link quality of a first hop between the fourth U2U relay candidate and the first wireless terminal is lower than the eighth threshold, or
a ninth threshold configured/used to filter out a fifth U2U relay candidate if a link quality of a second hop between the fifth U2U relay candidate and the second wireless terminal is lower than the ninth threshold.

In an embodiment, the SL measurement configuration is associated with (e.g. configured for) an ID (e.g. L2 ID or a local UE ID) of the second wireless terminal.

In an embodiment, the first wireless terminal may receive a path switch configuration from the first wireless network node. The path switch configuration may indicate a path switch towards an indirect SL which is between the first wireless terminal and the second wireless terminal and served by a third wireless terminal (e.g. U2U relay UE). For example, the path switch configuration may comprise at least one of:
an ID of the second wireless terminal,
an ID of the third wireless terminal, or
a timer value of a path switch timer associated with the path switch.

In an embodiment, the first wireless terminal may start the path switch timer when/upon receiving the path switch configuration.

In an embodiment, the first wireless terminal may stop the path switch timer at least one of the following events:
when a first PC5 link between the first wireless terminal and the third wireless terminal and a second PC5 link between the third wireless terminal and the second wireless terminal are established,
transmitting, to the third wireless terminal, an RRC reconfiguration SL message successfully,
receiving, from the third wireless terminal, a PC5 radio link control acknowledge,
receiving, from the third wireless terminal, an RRC reconfiguration complete SL message,
receiving, from the second wireless terminal, a PDCP acknowledge (message),
receiving, from the third wireless terminal, an E2E direct communication response from the second wireless terminal via the third wireless terminal,
transmitting, to the third wireless terminal, an E2E L2 link modification request message successfully, or
receiving, from the third wireless terminal, an E2E L2 link modification accept message.

In an embodiment, at an expiry of the path switch timer, the first wireless terminal may initiate a relay reselection procedure. As an alternative or in addition, the first wireless terminal may transmit information of a path switch failure to the first wireless network node at an expiry of the path switch timer.

In an embodiment, the first wireless network node may transmit, to the first wireless network node, information comprising/indicating at least one of a path switch failure indication, a PC5 link setup failure indication, an ID of the second wireless terminal, an indication of a first hop between the first wireless terminal and the third wireless terminal, or an indication of a second hop between the third wireless terminal and the second wireless terminal. In an embodiment, the ID of the second wireless terminal is used to indicate that the path switch failure or the PC5 link setup failure occurs between the first wireless terminal (e.g. source UE) and the indicated second wireless terminal (e.g. target UE). In an embodiment, the first hop indication is configured to indicate that the path switch failure or the PC5 link setup failure occurs between the first hop (between the first wireless terminal and the third wireless terminal). In an embodiment, the second hop indication is configured to indicate that the path switch failure or the PC5 link setup failure occurs between the second hop (between the second wireless terminal and the third wireless terminal).

In an embodiment, the first wireless terminal may receive a failure report from the third wireless terminal. The failure report indicates a failure of a PC5 link setup between the third wireless terminal and the second wireless terminal.

In an embodiment, the first wireless terminal transmits an E2E PC5 RRC reconfiguration message indicating a PDCP data recovery to the second wireless terminal.

In an embodiment, the first wireless terminal transmits an E2E PC5 RRC message indicating a PDCP reestablishment to the second wireless terminal.

In an embodiment, the first wireless terminal receives an E2E PC5 RRC reconfiguration message indicating a PDCP data recovery from a second wireless terminal.

In an embodiment, the first wireless terminal receives an E2E PC5 RRC message indicating a PDCP reestablishment from the second wireless terminal.

In an embodiment, the first wireless terminal receives an SL configuration from the first wireless network node. The SL configuration may comprise at least one of an indication of a PDCP data recovery for an SL between the first wireless terminal and the second wireless terminal, an indication of a PDCP data recovery for each E2E SL DRB of an SL between the first wireless terminal and the second wireless terminal, an indication of a PDCP re-establishment for an SL between the first wireless terminal and the second wireless terminal, or an indication of a PDCP re-establishment for each E2E SL DRB of an SL between the first wireless terminal and the second wireless terminal.

In an embodiment, the first wireless terminal performs a PDCP data recovery or a PDCP reestablishment after the path switch towards the indirect SL which is between the first wireless terminal and the second wireless terminal and served by the third wireless terminal (is completed).

In an embodiment, the first wireless terminal receives information associated with the second wireless terminal from the third wireless terminal. The information associated with the second wireless terminal may comprise at least one of an RRC state, a serving cell information, or an outside-of-coverage indication.

In an embodiment, the first wireless terminal transmits information associated with the second wireless terminal to the first wireless network node. The information associated with the second wireless terminal may comprise at least one of an RRC state, a serving cell information, or an outside-of-coverage indication.

In an embodiment, the first wireless terminal transmits a measurement configuration comprising an ID of the second wireless terminal to a third wireless terminal. The third wireless terminal serves an indirect SL between the first wireless terminal and the second wireless terminal. That is the third wireless terminal is the U2U relay for the first wireless terminal and the second wireless terminal.

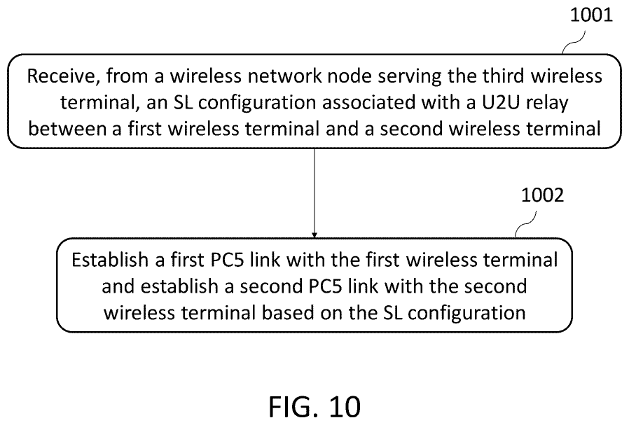

FIG. 10 shows a flowchart of a method according to an embodiment of the present disclosure. The method shown in FIG. 10 may be used in a third wireless terminal (e.g. relay UE, U2U relay UE) and comprises the following steps:

Step 1001: Receive, from a wireless network node serving the third wireless terminal, an SL configuration associated with a U2U relay between a first wireless terminal and a second wireless terminal.

Step 1002: Establish a first PC5 link with the first wireless terminal and establish a second PC5 link with the second wireless terminal based on the SL configuration.

In FIG. 10, the third wireless terminal may be selected to serve an indirect SL between a first wireless terminal (e.g. source UE) and a second wireless terminal (e.g. target UE). The third wireless terminal may receive an SL configuration from its serving wireless network node. Note that the serving wireless network node of the third wireless terminal may be the same with or different from that of the first wireless terminal. Based on the SL configuration, the third wireless terminal establishes a first PC5 link with the first wireless terminal (i.e. a first hop of the indirect SL) and a second PC5 link with the second wireless terminal (i.e. a second hop of the indirect SL), respectively.

In an embodiment, the SL configuration comprises at least one of
a U2U relay indication,
an ID of the first wireless terminal,
an ID of the second wireless terminal,
an ID of the pair of the first wireless terminal and the second wireless terminal,
a bearer mapping associated with an E2E SL SLRB to a PC5 RLC channel of the first hop over the indirect SL, or
a bearer mapping associated with an E2E SL SLRB to a PC5 RLC channel of the second hop over the indirect SL.

In an embodiment, the bearer mapping comprises at least one of an E2E SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

In an embodiment, the third wireless terminal transmits a failure report indicating a failure of establishing the second PC5 link to the first wireless terminal.

In an embodiment, the third wireless terminal transmits information of the second wireless terminal to the first wireless terminal. The information of the second wireless terminal comprises at least one of an RRC state, a serving cell information, or an outside-of-coverage indication.

In an embodiment, the third wireless terminal may receive a measurement configuration comprising an ID of the second wireless terminal from the first wireless terminal.

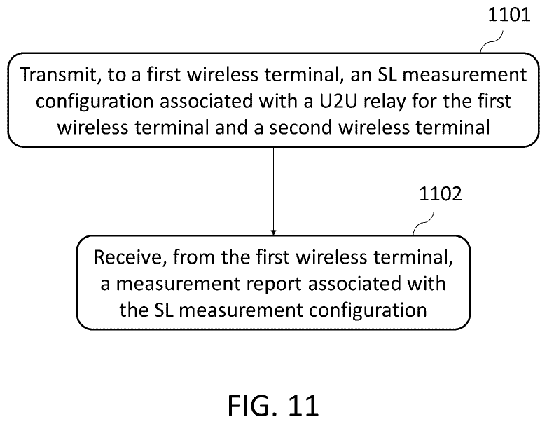

FIG. 11 shows a flowchart of a method according to an embodiment of the present disclosure. The method shown in FIG. 11 may be used in a first wireless network node (e.g. BS/gNB/RAN of a source UE) and comprises the following steps:

Step 1101: Transmit, to a first wireless terminal, an SL measurement configuration associated with a U2U relay for the first wireless terminal and a second wireless terminal.

Step 1102: Receive, from the first wireless terminal, a measurement report associated with the SL measurement configuration.

In FIG. 11, the first wireless network node may transmit an SL measurement configuration associated with a U2U relay for the first wireless terminal and a second wireless terminal. In an embodiment, the SL measurement configuration may be configured per second wireless terminal. As an alternative, the SL measurement configuration may be configured for any second wireless terminal communicating with the first wireless terminal via an (direct or indirect) SL.

In an embodiment, the SL measurement configuration comprises at least one of:
at least one threshold used in a measurement report event,
a filtering criterion of filtering the measurement report triggered by the measurement report event, or
a measurement quantity associated with the U2U relay.

In an embodiment, the measurement report event comprises at least one of:
a link quality of a direct SL between the first wireless terminal and the second wireless terminal is lower than a first threshold,
a link quality of a direct SL between the first wireless terminal and the second wireless terminal is lower than a second threshold and a link quality of a first hop between a first U2U relay candidate and the first wireless terminal is greater than a third threshold,
a link quality of a first hop between a second U2U relay candidate and the first wireless terminal is greater than a fourth threshold,
a link quality of a first hop between a third U2U relay candidate and the first wireless terminal and a link quality of a second hop between the third U2U relay candidate and the second wireless terminal are greater than a fifth threshold,
link qualities of a first hop and a second hop of an indirect SL are lower than a sixth threshold, wherein the first hop is between the first wireless terminal and the U2U relay serving the indirect SL for the first wireless terminal and the second wireless terminal and the second hop is between the second wireless terminal and the U2U relay serving the indirect SL for the first wireless terminal and the second wireless terminal, or
a link quality of the direct SL between the first wireless terminal and the second wireless terminal is greater than a seventh threshold.

In an embodiment, the filtering criterion/criteria comprise at least one of:
an eighth threshold configured/used to filter out a fourth U2U relay candidate if a link quality of a first hop between the fourth U2U relay candidate and the first wireless terminal is lower than the eighth threshold, or
a ninth threshold configured/used to filter out a fifth U2U relay candidate if a link quality of a second hop between the fifth U2U relay candidate and the second wireless terminal is lower than the ninth threshold.

In an embodiment, the SL measurement configuration is associated with an ID (e.g. L2 ID or a local UE ID) of the second wireless terminal.

In an embodiment, the first wireless terminal may receive a path switch configuration from the first wireless network node. The path switch configuration may indicate a path switch towards an indirect SL which is between the first wireless terminal and the second wireless terminal and served by a third wireless terminal (e.g. U2U relay UE). For example, the path switch configuration may comprise at least one of:
an ID of the second wireless terminal,
an ID of the third wireless terminal, or
a timer value of a path switch timer associated with the path switch.

In an embodiment, the first wireless network node receives, from the first wireless terminal, information comprising at least one of a path switch failure indication, a PC5 link setup failure indication, an ID of the second wireless terminal, an indication of a first hop between the first wireless terminal and the third wireless terminal, or an indication of a second hop between the second wireless terminal and the third wireless terminal. In an embodiment, the ID of the second wireless terminal is used to indicate that the path switch failure or the PC5 link setup failure occurs between the first wireless terminal (e.g. source UE) and the indicated second wireless terminal (e.g. target UE). In an embodiment, the first hop indication is configured to indicate that the path switch failure or the PC5 link setup failure occurs between the first hop (between the first wireless terminal and the third wireless terminal). In an embodiment, the second hop indication is configured to indicate that the path switch failure or the PC5 link setup failure occurs between the second hop (between the second wireless terminal and the third wireless terminal).

In an embodiment, the first wireless network node transmits an SL configuration to the first wireless terminal. The SL configuration (transmitted to the first wireless terminal) comprises at least one of an indication of a PDCP data recovery for an SL between the first wireless terminal and the second wireless terminal, an indication of a PDCP data recovery for each E2E SL DRB of an SL between the first wireless terminal and the second wireless terminal, an indication of a PDCP re-establishment for an SL between the first wireless terminal and the second wireless terminal, or an indication of a PDCP re-establishment for each E2E SL DRB of an SL between the first wireless terminal and the second wireless terminal.

In an embodiment, the first wireless network node may transmit an SL configuration associated with a U2U relay between the first wireless terminal and the second wireless terminal to a third wireless terminal. For example, the third wireless terminal may be selected to be the U2U relay for the first wireless terminal and the second wireless terminal (based on the measurement report).

In an embodiment, the SL configuration (transmitted to the third wireless terminal) comprises at least one of
a U2U relay indication,
an ID of the first wireless terminal,
an ID of the second wireless terminal,
an ID of the pair of the first wireless terminal and the second wireless terminal,
a bearer mapping associated with an E2E SLRB to a PC5 RLC channel of a first hop over an indirect SL, wherein the first hop is between the third wireless terminal and the first wireless terminal and the indirect SL is between the first wireless terminal and the second wireless terminal and is through the third wireless terminal, or
a bearer mapping associated with an E2E SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal.

In an embodiment, the bearer mapping comprises at least one of an E2E SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

In an embodiment, the first wireless network node transmits SL relay assistance information associated with a third wireless terminal to a second wireless network node (serving the third wireless terminal). In this embodiment, the third wireless terminal may be selected to be a U2U relay for the first wireless terminal and the second wireless terminal (e.g. based on the measurement report).

In an embodiment, the SL relay assistance information comprises at least one of:
serving cell information of the third wireless terminal,
an ID of the third wireless terminal,
an ID of the first wireless terminal,
an ID of the second wireless terminal,
a bearer mapping between an SL signaling radio bearer, SRB and a PC5 RLC channel,
a mapping between an SL data radio bearer, DRB, and at least one QoS flow,
a bearer mapping between an SL DRB and a PC5 RLC channel,
a packet delay budget, PDB, associated with each PC5 RLC channel,
a PDB associated with each SL DRB,
a control plane indication of each PC5 RLC channel, or
a channel configuration for each PC5 RLC channel.

In an embodiment, the first wireless network node may receive information of the second wireless terminal from the first wireless terminal. The information of the second wireless terminal may comprise at least one of an RRC state, a serving cell information, or an outside-of-coverage indication.

In an embodiment, the first wireless network node may transmit send SL related information to a third wireless network node serving the second wireless terminal, e.g. to negotiate/determine which U2U relay UE should be selected. The SL related information is transmitted/generated based on the SL measurement report and the information of the second wireless terminal received from the first wireless terminal UE. For instance, the SL related information may include at least one of: the (L2) ID of the first wireless terminal, the (L2) ID of the second wireless terminal, a list of U2U relay candidates, a selected U2U relay, the RRC state of each U2U relay candidate, a PC5 link quality between the first wireless terminal and each U2U relay candidate, or a PC5 link quality between each U2U relay candidate and the second wireless terminal.

In an embodiment, the first wireless network node may receive a selected relay wireless terminal for (relaying data transmissions between) the first wireless terminal and the second wireless terminal from the third wireless network node.

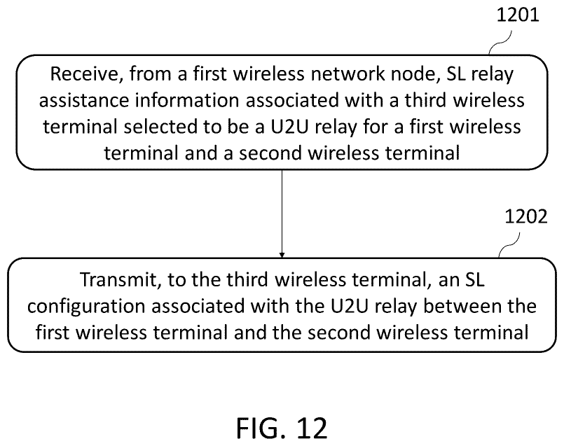

FIG. 12 shows a flowchart of a method according to an embodiment of the present disclosure. The method shown in FIG. 12 may be used in a second wireless network node (e.g. BS, gNB, RAN (node)) and comprises the following steps:

Step 1201: Receive, from a first wireless network node, SL relay assistance information associated with a third wireless terminal selected to be a U2U relay for a first wireless terminal and a second wireless terminal.

Step 1202: Transmit, to the third wireless terminal, an SL configuration associated with the U2U relay between the first wireless terminal and the second wireless terminal.

In this embodiment, the second wireless network node receive SL relay assistance information associated with a third wireless terminal from a first wireless network node. In this embodiment, the third wireless terminal is selected to be a U2U relay for a first wireless terminal and a second wireless terminal. The third wireless terminal is served by the second wireless network node.

In an embodiment, the SL relay assistance information comprises at least one of:
serving cell information of the third wireless terminal,
an ID of the third wireless terminal,
an ID of the first wireless terminal,
an ID of the second wireless terminal,
a bearer mapping between an SL signaling radio bearer, SRB and a PC5 RLC channel,
a mapping between an SL data radio bearer, DRB, and at least one QoS flow,
a bearer mapping between an SL DRB and a PC5 RLC channel,
a packet delay budget, PDB, associated with each PC5 RLC channel,
a PDB associated with each SL DRB,
a control plane indication of each PC5 RLC channel, or
a channel configuration for each PC5 RLC channel.

In an embodiment, the SL configuration (transmitted to the third wireless terminal) comprises at least one of
a U2U relay indication,
at least one ID associated with the first wireless terminal and the second wireless terminal,
a bearer mapping associated with an E2E SLRB to a PC5 RLC channel of a first hop over an indirect SL, wherein the first hop is between the third wireless terminal and the first wireless terminal and the indirect SL is between the first wireless terminal and the second wireless terminal and is through the third wireless terminal, or
a bearer mapping associated with an E2E SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal.

In an embodiment, the bearer mapping comprises at least one of an E2E SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method for use in a first wireless terminal, the wireless communication method comprising:
receiving, from a first wireless network node, a sidelink (SL) measurement configuration associated with a user-to-user relay for the first wireless terminal and a second wireless terminal, and
transmitting, to the first wireless network node, a measurement report based on the measurement configuration.

2. The wireless communication method of claim 1, wherein the SL measurement configuration comprises at least one of:
at least one threshold used in a measurement report event,
a filtering criterion of filtering the measurement report triggered by the measurement report event, or
a measurement quantity associated with the user-to-user relay.

3. The wireless communication method of claim 2, wherein the measurement report event comprises at least one of:
a link quality of a direct SL between the first wireless terminal and the second wireless terminal is lower than a first threshold,
a link quality of a direct SL between the first wireless terminal and the second wireless terminal is lower than a second threshold and a link quality of a first hop between a first user-to-user relay candidate and the first wireless terminal is greater than a third threshold,
a link quality of a first hop between a second user-to-user relay candidate and the first wireless terminal is greater than a fourth threshold,
a link quality of a first hop between a third user-to-user relay candidate and the first wireless terminal and a link quality of a second hop between the third user-to-user relay candidate and the second wireless terminal are greater than a fifth threshold,
link qualities of a first hop and a second hop of an indirect SL are lower than a sixth threshold, wherein the first hop is between the first wireless terminal and the user-to-user relay serving the indirect SL for the first wireless terminal and the second wireless terminal and the second hop is between the second wireless terminal and the user-to-user relay serving the indirect SL for the first wireless terminal and the second wireless terminal, or
a link quality of the direct SL between the first wireless terminal and the second wireless terminal is greater than a seventh threshold.

4. The wireless communication method of claim 2, wherein the filtering criterion comprises at least one of:
an eighth threshold configured to filter out a fourth user-to-user relay candidate if a link quality of a first hop between the fourth user-to-user relay candidate and the first wireless terminal is lower than the eighth threshold, or
a ninth threshold configured to filter out a fifth user-to-user relay candidate if a link quality of a second hop between the fifth user-to-user relay candidate and the second wireless terminal is lower than the ninth threshold.

5. The wireless communication method of claim 1, wherein the SL measurement configuration is associated with an identifier (ID) of the second wireless terminal.

6. The wireless communication method of claim 1, further comprising:
receiving, from the first wireless network node, a path switch configuration indicating a path switch towards an indirect SL which is between the first wireless terminal and the second wireless terminal and served by a third wireless terminal,
wherein the path switch configuration comprises at least one of:
an ID of the second wireless terminal,
an ID of the third wireless terminal, or
a timer value of a path switch timer associated with the path switch.

7. The wireless communication method of claim 6, further comprising at least one of:
starting the path switch timer when receiving the path switch configuration, or
stopping the path switch timer at the time of at least one of:
when a first PC5 link between the first wireless terminal and the third wireless terminal and a second PC5 link between the third wireless terminal and the second wireless terminal are established,
transmitting, to the third wireless terminal, a radio resource control (RRC) reconfiguration SL message successfully,
receiving, from the third wireless terminal, a PC5 radio link control acknowledge,
receiving, from the third wireless terminal, an RRC reconfiguration complete SL message,
receiving, from the second wireless terminal, a packet data convergence protocol (PDCP) acknowledge,
receiving, from the third wireless terminal, an end-to-end direct communication response from the second wireless terminal via the third wireless terminal,
transmitting, to the third wireless terminal, an end-to-end layer 2 link modification request message successfully, or
receiving, from the third wireless terminal, an end-to-end layer 2 link modification accept message.

8. The wireless communication method of claim 6,
wherein, at an expiry of the path switch timer, the method further comprises at least one of:
initiating a relay reselection procedure, or
transmitting, to the first wireless network node, information of a path switch failure.

9. The wireless communication method of claim 6, further comprising at least one of:
transmitting, to the first wireless network node, information comprising at least one of a path switch failure indication, a PC5 link setup failure indication, an ID of the second wireless terminal, an indication of a first hop between the first wireless terminal and the third wireless terminal, or an indication of a second hop between the third wireless terminal and the second wireless terminal;
receiving, from the third wireless terminal, a failure report indicating a failure of a PC5 link setup between the third wireless terminal and the second wireless terminal;
transmitting, to the second wireless terminal, an end-to-end PC5 RRC reconfiguration message indicating a PDCP data recovery,
transmitting, to the second wireless terminal, an end-to-end PC5 RRC message indicating a PDCP reestablishment,
receiving, from the second wireless terminal, an end-to-end PC5 RRC reconfiguration message indicating a PDCP data recovery,
receiving, from the second wireless terminal, an end-to-end PC5 RRC message indicating a PDCP reestablishment,
receiving, from the first wireless network node, an SL configuration comprising at least one of an indication of a PDCP data recovery for an SL between the first wireless terminal and the second wireless terminal, an indication of a PDCP data recovery for each end-to-end SL data radio bearer, DRB, of an SL between the first wireless terminal and the second wireless terminal, an indication of a PDCP re-establishment for an SL between the first wireless terminal and the second wireless terminal, or an indication of a PDCP re-establishment for each end-to-end SL DRB of an SL between the first wireless terminal and the second wireless terminal, or
performing a PDCP data recovery or a PDCP reestablishment after the path switch towards the indirect SL which is between the first wireless terminal and the second wireless terminal and served by the third wireless terminal.

10. The wireless communication method of claim 1, further comprising at least one of:
receiving, from the third wireless terminal, information of the second wireless terminal,
wherein the information of the second wireless terminal comprises at least one of a radio resource control state, a serving cell information, or an outside-of-coverage indication;
transmitting, to the first wireless network node, information of the second wireless terminal,
wherein the information of the second wireless terminal comprises at least one of a radio resource control state, a serving cell information, or an outside-of-coverage indication; or
transmitting, to a third wireless terminal serving an indirect SL between the first wireless terminal and the second wireless terminal, a measurement configuration comprising an ID of the second wireless terminal.

11. A wireless communication method for use in a first wireless network node, the wireless communication method comprising:
transmitting, to a first wireless terminal, a sidelink (SL) measurement configuration associated with a user-to-user relay for the first wireless terminal and a second wireless terminal, and
receiving, from the first wireless terminal, a measurement report associated with the SL measurement configuration.

12. The wireless communication method of claim 11, wherein the SL measurement configuration comprises at least one of:
at least one threshold used in a measurement report event,
a filtering criterion of filtering the measurement report triggered by the measurement report event, or
a measurement quantity associated with the user-to-user relay.

13. The wireless communication method of claim 12, wherein the measurement report event comprises at least one of:
a link quality of a direct SL between the first wireless terminal and the second wireless terminal is lower than a first threshold,
a link quality of a direct SL between the first wireless terminal and the second wireless terminal is lower than a second threshold and a link quality of a first hop between a first user-to-user relay candidate and the first wireless terminal is greater than a third threshold,
a link quality of a first hop between a second user-to-user relay candidate and the first wireless terminal is greater than a fourth threshold,
a link quality of a first hop between a third user-to-user relay candidate and the first wireless terminal and a link quality of a second hop between the third user-to-user relay candidate and the second wireless terminal are greater than a fifth threshold,
link qualities of a first hop and a second hop of an indirect SL are lower than a sixth threshold, wherein the first hop is between the first wireless terminal and the user-to-user relay serving the indirect SL for the first wireless terminal and the second wireless terminal and the second hop is between the second wireless terminal and the user-to-user relay serving the indirect SL for the first wireless terminal and the second wireless terminal, or
a link quality of the direct SL between the first wireless terminal and the second wireless terminal is greater than a seventh threshold,
wherein the filtering criterion comprises at least one of:
an eighth threshold configured to filter out a fourth user-to-user relay candidate if a link quality of a first hop between the fourth user-to-user relay candidate and the first wireless terminal is lower than the eighth threshold, or
a ninth threshold configured to filter out a fifth user-to-user relay candidate if a link quality of a second hop between the fifth user-to-user relay candidate and the second wireless terminal is lower than the ninth threshold.

14. The wireless communication method of claim 11, wherein the SL measurement configuration is associated with an identifier (ID) of the second wireless terminal.

15. The wireless communication method of claim 11, further comprising at least one of:
transmitting, to the first wireless terminal, a path switch configuration indicating a path switch towards an indirect SL which is between the first wireless terminal and the second wireless terminal and served by a third wireless terminal,
wherein the path switch configuration comprises at least one of:
an ID of the second wireless terminal,
an ID of the third wireless terminal, or
a timer value of a path switch timer for the path switch; or
receiving, from the first wireless terminal, information comprising at least one of a path switch failure indication, a PC5 link setup failure indication, an ID of the second wireless terminal, an indication of a first hop between the first wireless terminal and the third wireless terminal, or an indication of a second hop between the second wireless terminal and the third wireless terminal.

16. The wireless communication method of claim 11, further comprising at least one of:
transmitting, to the first wireless terminal, an SL configuration comprising at least one of an indication of a packet data convergence protocol (PDCP) data recovery for an SL between the first wireless terminal and the second wireless terminal, an indication of a PDCP data recovery for each end-to-end SL data radio bearer (DRB) of an SL between the first wireless terminal and the second wireless terminal, an indication of a PDCP re-establishment for an SL between the first wireless terminal and the second wireless terminal, or an indication of a PDCP re-establishment for each end-to-end SL DRB of an SL between the first wireless terminal and the second wireless terminal; or
transmitting, to a third wireless terminal, an SL configuration associated with a user-to-user relay between the first wireless terminal and the second wireless terminal,
wherein the third wireless terminal is selected to be the user-to-user relay for the first wireless terminal and the second wireless terminal based on the measurement report.

17. The wireless communication method of claim 16, wherein the SL configuration comprises at least one of:
a user-to-user relay indication,
an ID of the first wireless terminal,
an ID of the second wireless terminal,
a bearer mapping associated with an end-to-end SL radio bearer (SLRB) to a PC5 radio link control, RLC, channel of a first hop over an indirect SL, wherein the first hop is between the third wireless terminal and the first wireless terminal and the indirect SL is between the first wireless terminal and the second wireless terminal and is through the third wireless terminal, or
a bearer mapping associated with an end-to-end SL SLRB to a PC5 RLC channel of a second hop over an indirect SL, wherein the second hop is between the third wireless terminal and the second wireless terminal and the indirect SL is between the first wireless terminal and the second wireless terminal and is through the third wireless terminal,
wherein the bearer mapping comprises at least one of an end-to-end SLRB ID, a PC5 RLC channel ID of the first hop, a PC5 RLC channel ID of the second hop, an ingress PC5 RLC channel ID, an egress PC5 RLC channel ID, a PC5 RLC channel ID between the first wireless terminal and the third wireless terminal, or a PC5 RLC channel ID between the third wireless terminal and the second wireless terminal.

18. The wireless communication method of claim 11, further comprising:
transmitting, to a second wireless network node, SL relay assistance information associated with a third wireless terminal,
wherein the third wireless terminal is selected to be a user-to-user relay for the first wireless terminal and the second wireless terminal based on the measurement report and is served by the second wireless network node,
wherein the SL relay assistance information comprises at least one of:
serving cell information of the third wireless terminal,
an ID of the third wireless terminal,
an ID of the first wireless terminal,
an ID of the second wireless terminal,
a bearer mapping between an SL signaling radio bearer, SRB and a PC5 RLC channel,
a mapping between an SL data radio bearer, DRB, and at least one quality of service, QoS, flow,
a bearer mapping between an SL DRB and a PC5 RLC channel,
a packet delay budget, PDB, associated with each PC5 RLC channel,
a PDB associated with each SL DRB,
a control plane indication of each PC5 RLC channel, or
a channel configuration for each PC5 RLC channel; or
further comprising:
receiving, from the first wireless terminal, information of the second wireless terminal,
wherein the information of the second wireless terminal comprises at least one of a radio resource control state, a serving cell information, or an outside-of-coverage indication.

19. A first wireless terminal, comprising:
a communication unit, configured to:
receive, from a first wireless network node, a sidelink (SL) measurement configuration associated with a user-to-user relay for the first wireless terminal and a second wireless terminal, and
transmit, to the first wireless network node, a measurement report based on the measurement configuration.

20. A first wireless network node, comprising a communication unit, wherein the communication unit is configured to perform the wireless communication method of claim 11.
